(19) United States
(12) Patent Application Publication
(10) Pub. No.: US 2014/0093017 A1
(43) Pub. Date: Apr. 3, 2014

(54) Joint Processing in Cooperative Radio Communications Networks

(71) Applicants: Afif Osseiran, Kista (SE); Slimane Ben Slimane, Saltsjo Boo (SE)

(72) Inventors: Afif Osseiran, Kista (SE); Slimane Ben Slimane, Saltsjo Boo (SE)

(73) Assignee: TELEFONAKTIEBOLAGET L M ERICSSON (PUBL), Stockholm (SE)

(21) Appl. No.: 14/117,769

(22) PCT Filed: May 18, 2011
(86) PCT No.: PCT/SE2011/050627

§ 371 Date: Nov. 14, 2013

(51) Int. Cl. H04L 1/00

(52) U.S. Cl. CPC H04L 1/0054
USPC 375/341; 375/340

(57) ABSTRACT

A first radio frequency, RF, signal is directly received from a first source radio node in a radio destination node. The first RF signal includes a coded first source information signal. A second RF signal is directly received from a second source radio node that includes a coded second source information signal. A third RF signal is received from an intermediate network node that includes a network coded signal which is a combined coded information signal generated at the intermediate node after demodulating the coded first source information signal and the coded second source information signal received from the first and second source radio nodes. The coded first source information signal, the coded second source information signal, and the combined coded information signal are jointly processed to produce

### TECHNICAL FIELD

The technology relates to radio communication, and more particularly, to decoding of received radio signals in a cooperative radio communications network.

### BACKGROUND

An important objective in developing wireless/cellular communication systems is to provide increased coverage and/or support for higher data rates. At the same time, the cost associated with building and maintaining such systems is also important. As data rates and/or communication distances increase, increased user equipment (UE) battery consumption is another area of concern. Until recently, the topology of wireless communication systems has remained fairly unchanged, including the three existing generations of cellular networks. That topology is characterized by a cellular architecture with the typical macro radio base stations and mobile radio stations being the only radio transmitting and receiving entities involved in a radio communication session.

One way to introduce diversity in a received radio signal is to exploit the spatial diversity offered when multiple antennas are used at the transmitter with the possibility of using one or more antennas at the receiver. Multiple antenna systems offer significant diversity and multiplexing gains relative to single antenna systems. Multiple-Input Multiple-Output (MIMO) wireless systems can thus improve radio link reliability and spectral efficiency relative to Single-Input Single-Output (SISO) systems. Another technology that offers macro-diversity is relay or distributed systems like distributed antenna systems (DAS) or cooperative systems. A relay system is a conventional radio network that is complemented with relay nodes that communicate wirelessly with other network elements like macro and micro base stations, another relay, or a user equipment (UE). In a cooperative relaying system, the source information sent to an intended destination is conveyed through various routes and combined at the destination. Each route may include one or more hops using the relay nodes. In addition, the destination node may receive the direct signal from the source node, where the direct signal does not pass through any intermediary hop node. Cooperative relaying systems may be divided into numerous categories based on desired parameters. One example includes the way the signal is forwarded and encoded at the relay station. One category is amplify-and-forward, and another category is decode-and-forward. In amplify-and-forward, a relay simply amplifies and forwards the received signal. In the decode-and-forward case, a relay demodulates and decodes the received signal prior to re-encoding and retransmitting it.

These present-day cellular communication networks share the same principle of operation: information sent from one source, O₁, to a destination, D, is transported independently from other information sent from another source, O₂, to the same destination D. Routers, repeaters, or relays simply forward the data to the destination. In contrast, Network Coding (NC) is a new area of networking in which data is manipulated inside the network at an intermediate node (N) to improve throughput, delay, and robustness. In particular, network coding allows the intermediate nodes to recombine several input packets into one or several output packets. At an intermediate node N (also referred to as a network coding node), linear coding may be performed on the information received and demodulated at the network coding node, and the resulting coded information is then broadcast for different recipients simultaneously instead of transmitting each information stream separately.

Linear network coding has been shown to be sufficient to achieve the maximum low bounds between the source-destination pairs in wired networks. Although initially mainly targeted at wired networks, recent work explores using network coding in wireless broadcast networks. Examples include Multiple Access Relay Channel (MARC), bidirectional relaying (also called two-way relaying), and multi-cast transmission.

Network coding can be used separately or jointly with channel coding, i.e., separate network-channel coding (SNCC) and joint network-channel coding (JNCC). It has been shown that joint network-channel coding exploits more effectively the relay transmission to obtain diversity gain as well as additional redundancy, especially in a MARC scenario. Unfortunately, existing joint network-channel coding based on turbo codes or low-density parity check (LDPC) codes requires iterative decoding and relies on exchanging soft information between multiple decoders at the receiver. One decoder is used for each user source stream. As a result, the required decoding is computationally intense and complex. In addition, the complex decoding operation used for JNCC is vulnerable to error propagation because of the soft information used between each of the multiple decoders. A solution is needed to these drawbacks.

### SUMMARY

A first aspect of the technology in this application relates to a method implemented in a radio destination node. A first radio frequency (RF) signal is directly received from a first source radio node. The first RF signal includes a coded first source information signal. A second RF signal is directly received from a second source radio node that is different from the first source radio node. The second RF signal includes a coded second source information signal. A third RF signal is received from an intermediate network node that includes a network coded signal which is a combined coded information signal generated at the intermediate node after demodulating the coded first source information signal and the coded second source information signal received from the first and second source radio nodes. The coded first source information signal, the coded second source information signal, and the combined coded information signal are jointly processed by operating on the coded first source information signal, the coded second source information signal, and the combined coded information signal together rather than individually to produce the first source information signal and the second source information signal.

In a non-example implementation, a decoding algorithm is used, such as the Viterbi algorithm, with a single trellis. One example embodiment allows the single trellis to selectively operate in one of a first operational mode using a first number of trellis states and a second operational mode using a second number of trellis states less than the first number. In the first operational mode, the jointly processing includes jointly decoding, using a single decoding algorithm, the coded first source information signal, the coded second source information signal, and the combined coded information signal together rather than individually to produce the first source information signal and the second source information signal. In the second operational mode, the joint processing is performed with the trellis using fewer decoding computations than are required to perform the jointly processing with the trellis in the first operational mode. In an example embodiment for the second operational mode, the jointly processing includes decoding symbols from one of the first and second source radio nodes using a trellis decoding metric which is minimized over the symbols of the other source node to simplify decoding using the trellis

The coded first source information may include a first set of code words and the coded second source information includes a second set of code words. The intermediate node coding may include a network coding operation on the first and second set of code words that combines the first and second set of code words. The first and second set of code words may be associated with different time periods. In one example implementation, the first coded source information and/or the second coded source information is/are convolutionally-encoded. Another example implementation has the first coded source information coded with a first coder structure and the second coded source information coded with a second different coder structure.

In one non-limiting example application, the source radio nodes are mobile user equipment nodes and the destination node is a radio base station. In other non-limiting example applications, the source radio nodes include radio base station nodes or radio base station node and other nodes, and the destination node is a mobile user equipment node.

Another aspect of the technology described in this application relates to an apparatus for a radio destination node. The apparatus includes a first signal processor is configured to demodulate a first RF signal received from a first source radio node. The first RF signal includes a coded first source information signal. A second signal processor is configured to demodulate a second RF signal received from a second source radio node that is different from the first source radio node. The second RF signal includes a coded second source information signal. A third signal processor is configured to demodulate a third RF signal from an intermediate network node that includes a combined coded information signal generated at the intermediate node after demodulating the coded first source information signal and the coded second source information signal received from the first and second source radio nodes. A joint processor is configured to jointly process the coded first source information signal, the coded second source information signal, and the combined coded information signal by operating on the coded first source information signal, the coded second source information signal, and the combined coded information signal together to produce the first source information signal and the second source information signal.

Another aspect of the technology described in this application relates to a radio base station that includes one or more antennas and a first radio receiver that demodulates a first RF signal received from a first UE radio node. The first RF signal includes a coded first UE information signal. A second radio receiver demodulates a second RF signal received from a second UE radio node that is different from the first UE radio node. The second RF signal including a coded second UE information signal. A third radio receiver demodulates a third RF signal received from an intermediate network node that includes a network coded signal which is a combined coded information signal generated at the intermediate node after demodulating the coded first UE information signal and the coded second UE information signal received from the first and second UE radio nodes. A joint processor jointly processes the coded first UE information signal, the coded second UE information signal, and the combined coded information signal by operating on the coded first UE information signal, the coded second UE information signal, and the combined coded information signal together rather than individually to produce the first UE information signal and the second UE information signal. A data processor provides the produced first and second UE information signals to a communications interface.

### BRIEF DESCRIPTION OF THE DRAWINGS

FIG. 1 is diagram illustrating an example uplink (UL) multiple access relay channel (MARC) cellular communications system;

FIG. 2 is a non-limiting, function block diagram of a source radio node;

FIG. 3 is a non-limiting, function block diagram of an intermediary or network coding radio node;

FIG. 4 is a non-limiting, function block diagram of a destination radio node;

FIG. 5 is a non-limiting flowchart illustrating example procedures for joint decoding in the destination radio node;

FIGS. 6A and 6B are non-limiting diagrams of an encoder and JNCC joint processor in the destination radio node, respectively, associated with a example optimal joint processing embodiment;

FIG. 7 is a non-limiting, example diagram of a decoding trellis that may be used by the joint processor to jointly decode coded signals received from two source radio nodes and one network coding radio node;

FIGS. 8A and 8B are non-limiting diagrams of an encoder and JNCC joint processor in the destination radio node, respectively, associated with a example simplified joint processor embodiment;

FIG. 9 is a non-limiting, example diagram of the simplified decoding trellis that may be used by the joint processor to jointly process coded signals received from two source radio nodes and one network coding radio node with less computational complexity;

FIG. 10 is an example graph illustrating a relationship between average bit error rate versus signal to noise ratio for various decoding approaches using over Additive White Gaussian Noise (AWGN) channels; and

FIG. 11 is an example graph illustrating a relationship between average bit error rate versus signal to noise ratio for various decoding approaches using over Rayleigh fading channels.

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, interfaces, circuits, and devices are omitted so as not obscure the description with unnecessary detail. Individual blocks may are shown in the figures corresponding to various nodes. Those skilled in the art will appreciate that the functions of those blocks may be implemented using individual hardware circuits, using software programs and data in conjunction with a suitably programmed digital microprocessor or general purpose computer, and/or using applications specific integrated circuitry (ASIC), and/or using one or more digital signal processors (DSPs). Nodes that communicate using the air interface also have suitable radio communications circuitry. The software program instructions and data may be stored on computer-readable storage medium, and when the instructions are executed by a computer or other suitable processor, the computer or processor performs the functions.

Thus, for example, it will be appreciated by those skilled in the art that diagrams herein can represent conceptual views of illustrative circuitry or other functional units. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various illustrated elements may be provided through the use of hardware such as circuit hardware and/or hardware capable of executing software in the form of coded instructions stored on computer-readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

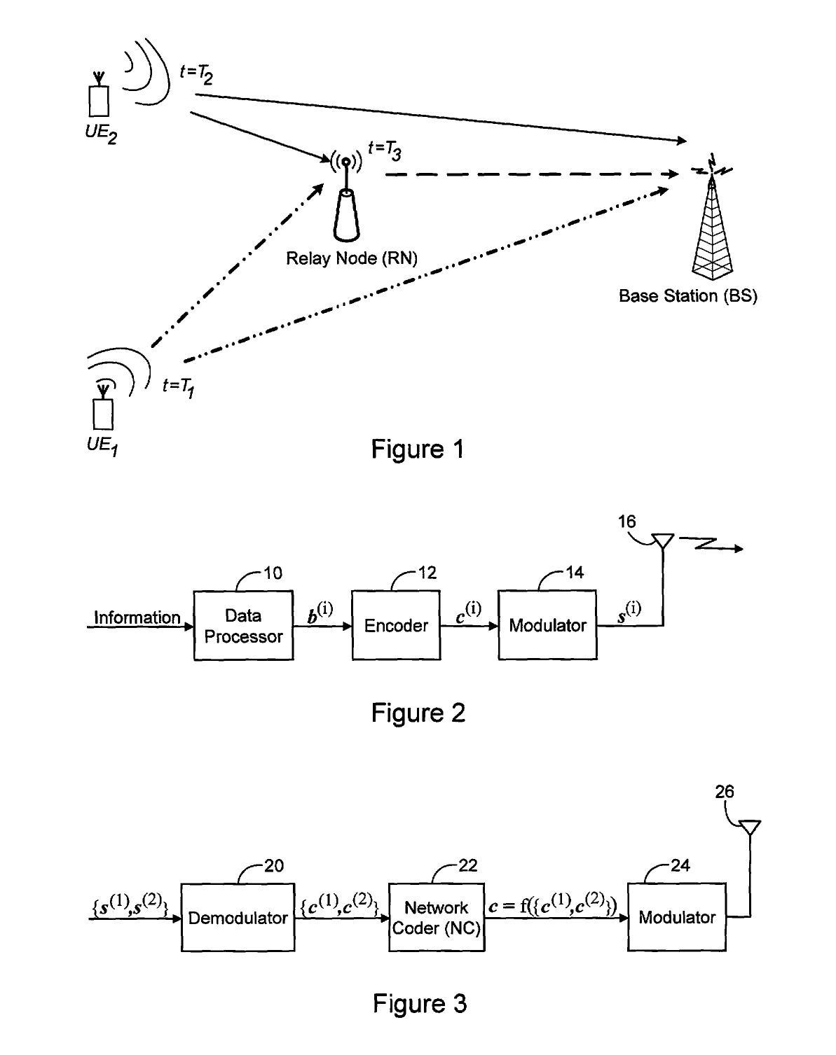

The technology described in this case may be applied to any communications system and/or network. But for purposes of illustration only, an example uplink (UL) multiple access relay channel (MARC) cellular communications system is shown in FIG. 1. For simplicity, the radio communication system includes two transmitting UEs, one relay node (RN), and one receive base station (BS). There can be more UEs, RNs, and BSs. Orthogonal Time Division Multiple Access (OTDMA) is assumed where the UEs and the relay node use different time slots for data transmission. The relay node may be half duplex and employ linear network coding. Alternatively, the relay node may be full duplex, and joint network-channel coding may be used in a two-way relaying scenario. The non-limiting examples of joint network-channel coding (JNCC) below are based on convolutional coding and its decoding structure for an UL MARC scenario are for illustration purposes only. Other types of coding and channels may be used.

Two user equipments UE1 and UE2 are shown as example source radio nodes that each encode its source information (e.g., bit sequence) and transmit the coded source information signal both directly to the base station (BS) destination node at time T1 and T2, respectively; and indirectly to the base station via a relay node (RN) also at time T1 and T2. The relay node receives, demodulates, and codes the source signals from UE1 and UE2 into a combined signal and then transmits the combined coded signal to the base station at a later time T3. The base station demodulates the signals from UE1, UE2, and RN and jointly processes them as described below to reproduce the source information originally transmitted by UE1 and UE2 at time T1 and T2, respectively. The base station's channel decoder operates as if the encoding operations at both UEs and the RN were performed by an equivalent single encoder. The joint processor forms a joint trellis for joint decoding using a single trellis rather than three separate trellises for each UE and for the RN. Alternatively, the technology may also be used in downlink communications with the base station being the source radio node and one or more UEs being the destination radio node(s).

FIG. 2 is a non-limiting, function block diagram of a source radio node. Information is processed in a data processor which generates an source information signal or bit sequence b⁽ⁱ⁾. A channel encoder 12 encodes (e.g., convolutionally encodes) the source information signal or bit sequence b⁽ⁱ⁾ and generates a coded source information signal or bit sequence c⁽ⁱ⁾. A modulator performs baseband modulation and frequency converts the modulated signal s⁽ⁱ⁾ to radio frequency (RF) for radio transmission via one or more antennas 16.

FIG. 3 is a non-limiting, function block diagram of an intermediary or network coding radio node, e.g., a relay node. At the relay node, the received data symbols sequences, s⁽¹⁾ and s⁽²⁾, from two source radio nodes, e.g., UE1 and UE2 in FIG. 1, are demodulated to produce code words c⁽¹⁾ and c⁽²⁾. Then, a network coder 22 applies a network coding (NC) operation on the code words c⁽¹⁾ and c⁽²⁾. The NC operation can be any desired kind of combining operation (binary or non-binary). The network coder 22 in the example of FIG. 3 indicates this NC combining operation as f({c⁽¹⁾, c⁽²⁾}). In a non-limiting, simple example, the NC combining operation may be an addition operation. For that case, the output of the NC 22 is simply c=c⁽¹⁾+c⁽²⁾. Thereafter, the NC-block is modulated by modulator 24 which also frequency converts the modulated signal to radio frequency (RF) for radio transmission via one or more antennas 26.

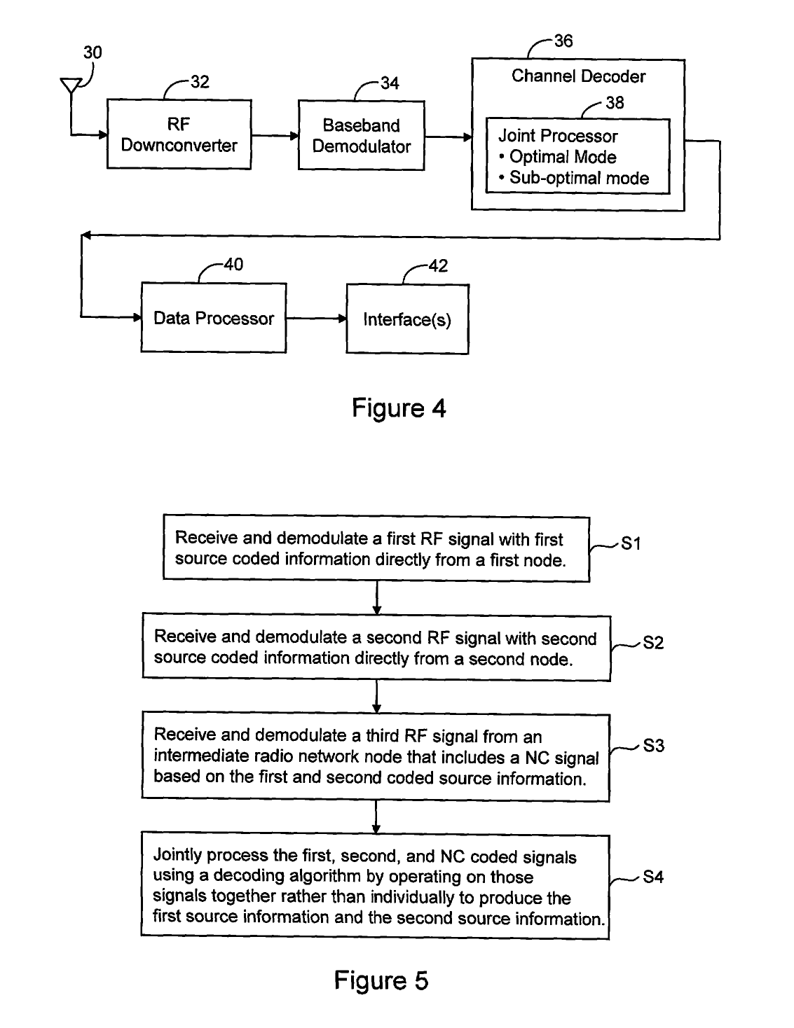

FIG. 4 is a non-limiting, function block diagram of a destination radio node. One or more antennas 30 receives RF signals from the source and relay nodes and frequency downconverts the received signals to baseband in RF downconverter 32. A baseband demodulator 34 demodulates the baseband signals to produce the coded bit streams associated with the first and second radio source nodes and the coded bit stream from the relay node. A channel decoder 36 performs channel decoding using a joint processor 38 that may include if desired more than one operational mode. An optimal joint processing mode and a sub-optimal mode are shown for illustration purposes.

The conventional way to decode the information at the destination node (e.g., a BS) is to decode separately the information received from the relay node and from each source radio node. But in FIG. 4, the information received from the relay node and from each source radio node is processed jointly together rather than individually to accomplish decoding of the source information from each source radio node. The destination node uses one joint trellis rather than three separate trellises, e.g., one for each user and one for the relay node.

FIG. 5 is a non-limiting flowchart illustrating example procedures for joint decoding in the destination radio node. The destination radio node directly receives a first RF signal (step S1) from a first source radio node. The first RF signal includes a coded first source information signal. The destination radio node also directly receives a second RF signal (step S2) from a second source radio node that is different from the first source radio node. The second RF signal includes a coded second source information signal. A third RF signal is also received (step S3) from an intermediate network node that includes a network coded signal which is a combined coded information signal generated at the intermediate node after demodulating the coded first source information signal and the coded second source information signal received from the first and second source radio nodes. The destination radio node jointly processes the coded first source information signal, the coded second source information signal, and the combined coded information signal (step S4) by operating on the coded first source information signal, the coded second source information signal, and the combined coded information signal together rather than individually to produce the first source information signal and the second source information signal.

Assume for illustration purposes only that convolutional coding is used. By considering the three received convolutionally coded words together (two directly from the source radio nodes and one from the relay radio node), the combined source coding and network coding may be seen as an augmented or equivalent convolutional code with a total number states v₁×v₂, where vᵢ is the number of states of the equivalent convolutional code used by the source node i.

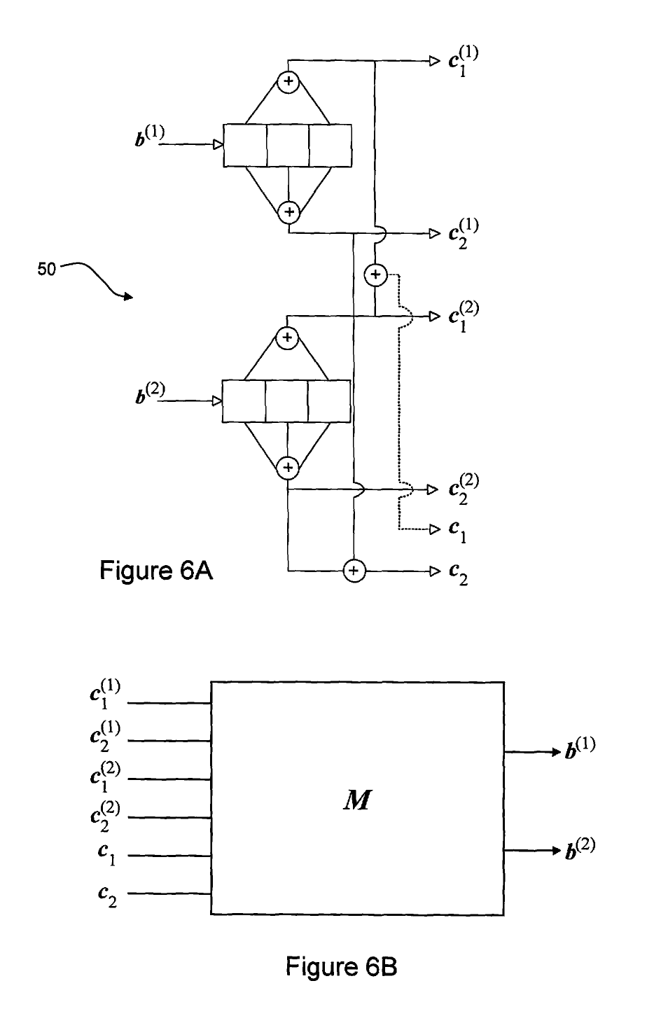

FIG. 6A is a non-limiting diagram of an equivalent encoder 50 representing the source and NC nodes associated with an example optimal joint decoding embodiment. The first source convolutional encoder, shown at the top of FIG. 6A, receives bit sequence b⁽¹⁾ and generates a first set of code words (coded sequences) c₁⁽¹⁾, c₂⁽¹⁾. The second source convolutional encoder, shown at the bottom of FIG. 6A, receives bit sequence b⁽²⁾ and generates a first set of code words (coded sequences) c₁⁽²⁾, c₂⁽²⁾. Outputs from the two convolutional encoders are used to generate the NC code words c₁ and c₂.

FIG. 6B is a non-limiting diagram of the JNCC joint decoder 38 in the destination radio node associated with the example optimal joint decoding embodiment. Using these received coded words c₁⁽¹⁾, c₂⁽¹⁾, c₁⁽²⁾, c₂⁽²⁾, c₁, and c₂ as inputs, the joint decoder 38 may apply a single decoding algorithm, e.g., the Viterbi decoding algorithm, shown as block M to decode and extract the source information b⁽¹⁾ and b⁽²⁾ from the two source radio nodes. Equation (4) implemented in block M is given below. Instead of decoding each encoded sequence separately, the joint decoder 38 jointly decodes together the three encoded sequences (represented as c⁽¹⁾, c⁽²⁾, and c) and takes into account the NC operation.

More generally, if the source radio node i employs a convolutional code with rate Rᵢ=kᵢ/nᵢ and a total number of states vᵢ, where kᵢ is the length of the information bits, i.e., the input at the encoder, and nᵢ the size of coded block length, i.e., the output of the encoder, then the equivalent code that takes into account the network operation at the relay node and the coding operations at the source radio nodes seen at the destination radio node is a convolutional code with rate:

$${R}_{e} = \frac{{k}_{1} + {k}_{2}}{{n}_{1} + {n}_{2} + max \{ {n}_{1} , {n}_{2} \}}$$

and a total number of states v₁ and v₂.

Denoting by rᵢ, i=1, 2, the received coded word from source radio node i and by r₃ the received coded word from the relay node:

rᵢ=[r_{i,0}, r_{i,1}, . . . , r_{i,n}_{ᵢ}], i=1, 2 (1)

r₃=[r_{3,0}, r_{3,1}, . . . , r_{3,max{n}_{₁}_{,n}_{₂}_{}}] (2)

For a flat fading multipath channel, the received samples may be written as follows:

r_{i,k}=hᵢs_{i,k}+z_{i,k}, i=1, 2, 3 (3)

where s_{i, k} is the modulated symbol of the coded bit c_{i, k}. For a non-limiting BPSK type baseband modulation example, s_{i,k}=2c_{i,k}−1. If the joint decoder performs an optimized version of the Viterbi decoding algorithm, in accordance with a non-limiting example embodiment, the information of both source radio nodes i=1,2 is decoded simultaneously, and the joint Viterbi decoder bases its path metric distance calculations using the following branch metric:

$$M = {\sum }_{k = 0}^{{n}_{1}} {\vert {r}_{1 , k} - {h}_{1 , k} {\hat{s}}_{1 , k} \vert}^{2} + {\sum }_{k = 0}^{{n}_{2}} {\vert {r}_{2 , k} - {h}_{2 , k} {\hat{s}}_{2 , k} \vert}^{2} + {\sum }_{k = 0}^{max \{ {n}_{1} , {n}_{2} \}} {\vert {r}_{3 , k} - {h}_{3 , k} {\hat{s}}_{3 , k} \vert}^{2} \qquad ( 4 )$$

As a non-limiting example, assume that the channel encoder at each source radio node is a convolutional encoder of constraint length K=3, as depicted in each encoder shown in FIG. 6. At the relay node, the demodulated sequences, {cⱼ⁽¹⁾, cⱼ⁽²⁾}, are network coded. In the example case of a simple addition, the network coding operation results in cⱼ=cⱼ⁽¹⁾+cⱼ⁽²⁾ where j=1, 2. The rate of the equivalent convolutional encoder in FIG. 4 is

$${R}_{e} = \frac{2 k}{3 n} = \frac{2}{6}$$

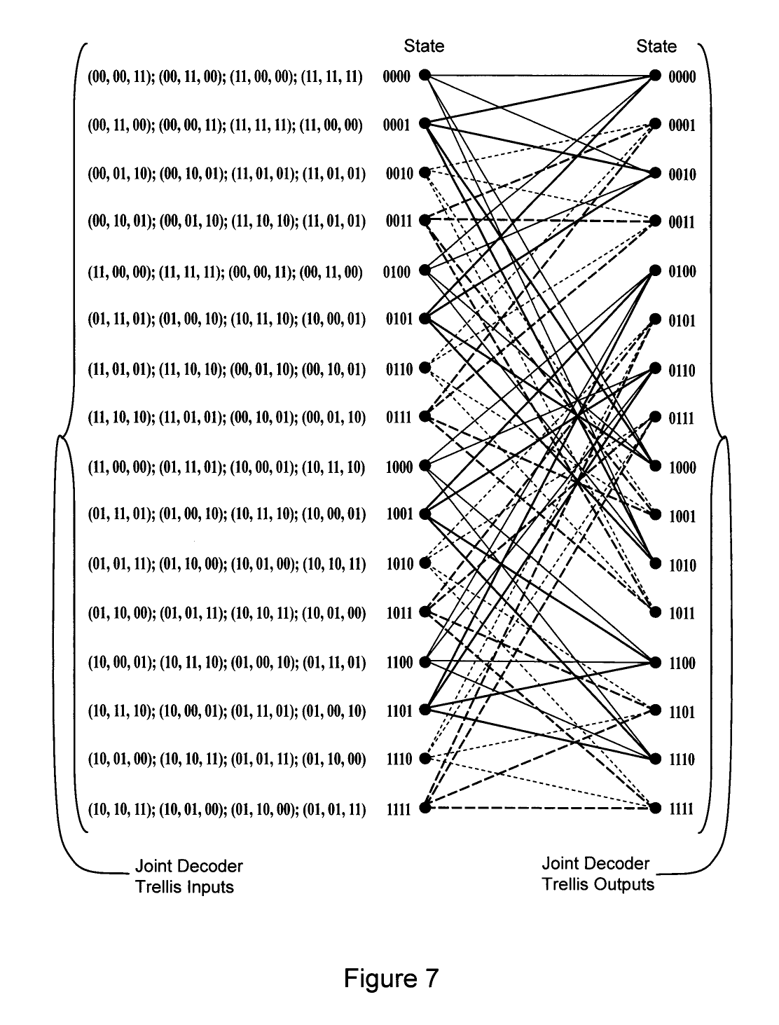

and the total number of states is v=v₁×v₂=16. The joint processor at the destination node applies the Viterbi algorithm using the decoding trellis shown in FIG. 7 formed from the equivalent encoder shown in FIG. 6. The trellis for the equivalent encoder includes 16 states whereas the trellis of each source radio node encoder includes 4 states.

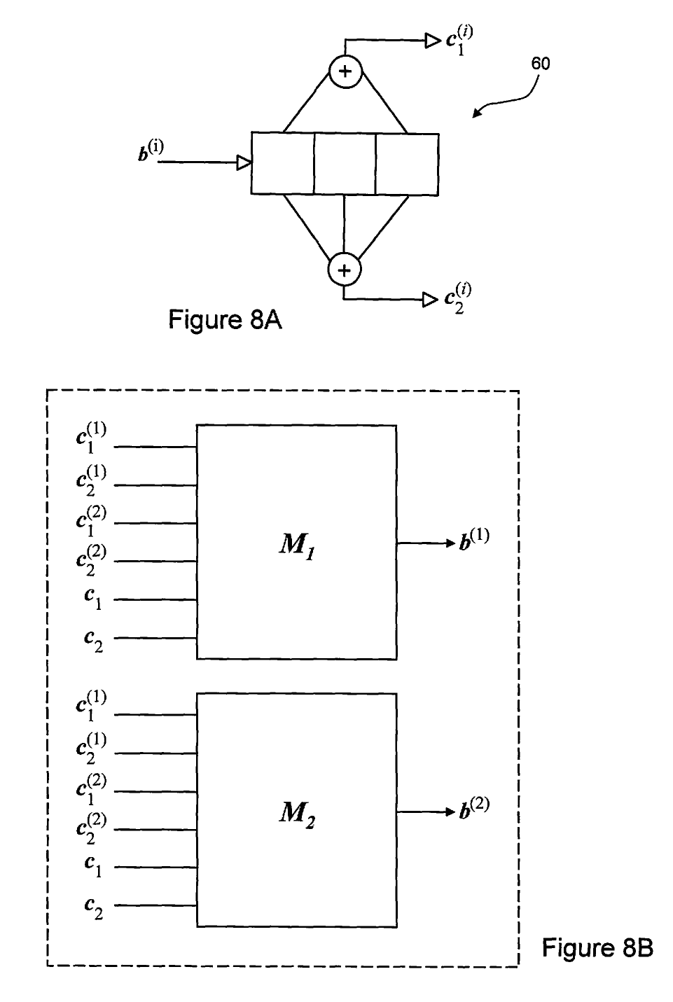

The number of trellis states used for the joint processing technology in the example embodiment described above (optimum joint processing) is equal to the product of the number of states of the source radio node encoders. FIG. 8A is a non-limiting diagram of a general encoder 60 associated with a less complex, though somewhat less optimal, joint processing example embodiment. Each source convolutional encoder receives a bit sequence b⁽ⁱ⁾ and generates a corresponding set of code words (coded sequences) c₁⁽ⁱ⁾, c₂⁽ⁱ⁾. The NC generates the code words c₁, c₂.

FIG. 8B is a non-limiting diagram of the JNCC joint processor 38 in the destination radio node associated with the example less complex, though somewhat less optimal, joint processing embodiment. Using these same received coded words c₁⁽¹⁾, c₂⁽¹⁾, c₁⁽²⁾, c₂⁽²⁾, c₁, and c₂ as inputs, the joint processor 38, operating in a lower complexity operational mode (which decoding mode may be selected manually, automatically, based on one or more detected conditions and/or criteria, etc.), may apply a simplified decoding algorithm based on branch metrics M₁ and M₂ for source nodes one and two, respectively, in order to decode and extract the source information b⁽¹⁾ and b⁽²⁾ from the two source radio nodes. Equation (8) implements M₁, the branch metric of source node one as given below. M₂ is derived in a similar fashion. In essence, the less complex joint processor 38 decodes the encoded sequences (represented as c⁽¹⁾, c⁽²⁾, and c) and takes into account the NC operation but uses a decoding metric which is minimized over the symbols of the other source node, thereby requiring less trellis states.

The simplified joint processing, though not optimal in one or more performance measures, has the added and offsetting benefit of reducing the computational complexity of the joint Viterbi decoding algorithm as compared to the more optimum full trellis described above. Denoting by rᵢ the received coded word from the source radio nodes and by r₃ the received coded word from the relay node:

rᵢ=[r_{i,0}, r_{i,1}, . . . , r_{i,n}_{ᵢ}], i=1, 2 (5)

r₃=[r_{3,0}, r_{3,1}, . . . , r_{3,max{n}_{₁}_{, n}_{₂}_{}}] (6)

For a flat fading multipath channel, the received samples can be written as follows:

r_{i,l}=hᵢs_{i,k}+z_{i,k}, i=1, 2, 3 (7)

where s_{i,k} is the modulated symbol of the coded bit c_{i,k}. Assume again BPSK baseband modulation s_{i,k}=2c_{i,k}−1. In the sub-optimal, joint processing embodiment, the path metric distance calculations use a simplified following branch metric M. For instance, the branch metric M₁ (resp. M₂) which allows decoding the data block of symbols s₁ (resp. s₂) for UE1 (resp. UE2) by minimizing over the modulated symbols s₂ (resp. s₁) of the other UE follows:

$${M}_{1} = {min}_{{s}_{2}} ( {\sum }_{k = 0}^{{n}_{1}} {\vert {r}_{1 , k} - {h}_{1 , k} {\hat{s}}_{1 , k} \vert}^{2} + {\sum }_{k = 0}^{{n}_{2}} {\vert {r}_{2 , k} - {h}_{2 , k} {\hat{s}}_{2 , k} \vert}^{2} + {\sum }_{k = 0}^{max \{ {n}_{1} , {n}_{2} \}} {\vert {r}_{3 , k} - {h}_{3 , k} {\hat{s}}_{3 , k} \vert}^{2} ) \qquad ( 8 )$$

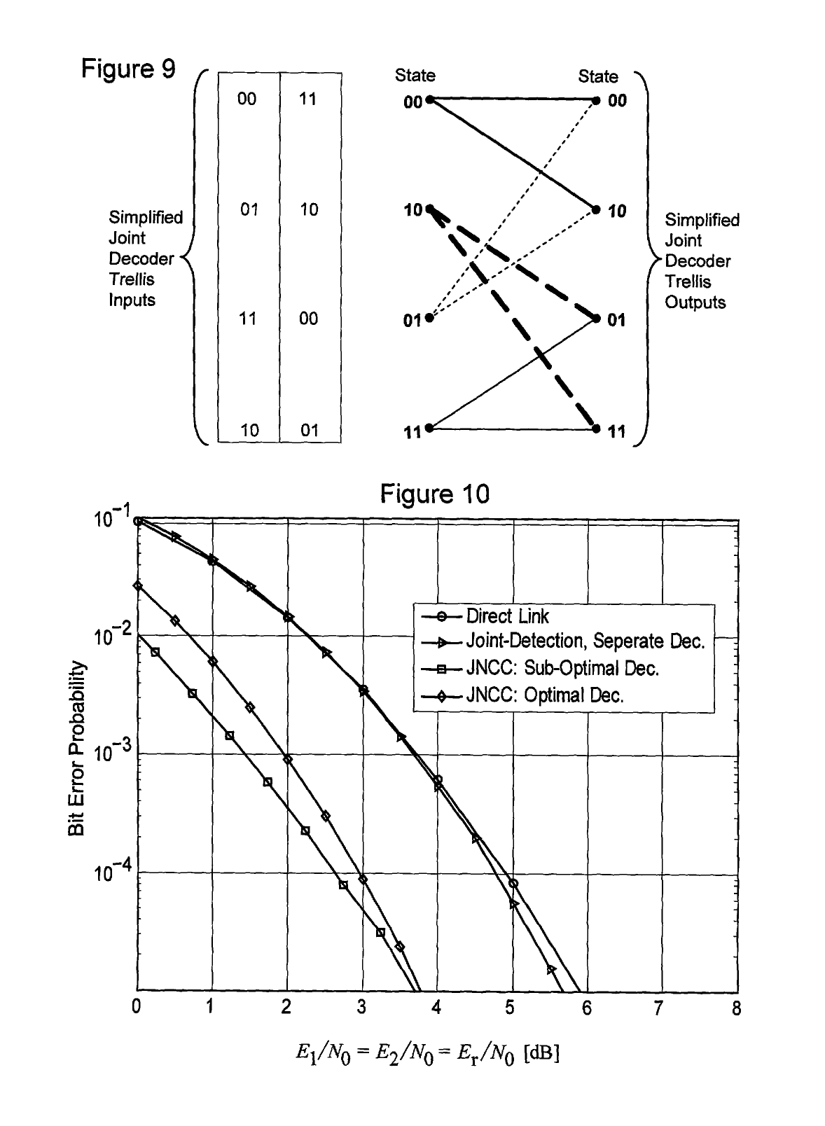

The equation for M₂ is the same as for M₁ except that the min operation is performed over the modulated symbols s₁ instead of symbols s₂. Note that in contrast with equation (7), equation (8) includes a minimize function for s₂ which effectively means that (in this example) the symbol sequence s₂ is fixed in order to reduce the number of computations needed for trellis decoding. This embodiment reduces the accuracy of the decoding somewhat but it also reduces the decoding complexity and power requirements. Assuming that the encoders at each UEs are identical to the ones shown in FIG. 3, then the equivalent trellis at the decoder for the sub-optimal joint processing includes four states rather than the sixteen as in the case for the optimum joint decoding approach for the trellis shown in FIG. 7. FIG. 9 shows a non-limiting, example diagram of the 4-state decoding trellis that may be used by the joint processor to jointly process decode coded signals received from two source radio nodes and one network coding radio node with less computational complexity.

One advantageous example application for either the optimal or non-optimal example joint processors is in a radio base station in a configuration like that shown in FIG. 1. Alternatively, the base station may selectively operate the decoding trellis in either of a first operational mode using a first number of trellis states or a second operational mode using a second number of trellis states less than the first number. In the second operational mode, the joint processing is performed with the sub-optimal trellis that uses fewer decoding computations than are required to perform the joint processing with the trellis in the first optimal operational mode.

FIG. 10 is an example graph illustrating a relationship between average bit error rate (BER) versus signal to noise ratio (SNR)for various decoding approaches over Additive White Gaussian Noise (AWGN) channels using the example scenario from FIG. 1. The three radio links (UE1, UE2, and relay node links) have the same average SNR, i.e.,

$$\frac{{E}_{1}}{{N}_{0}} = \frac{{E}_{2}}{{N}_{0}} = \frac{{E}_{3}}{{N}_{0}} .$$

The graph shows that the JNCC optimum joint processing algorithm provides a coding gain of more than 2 dB as compared to joint detection and separate/individual decoding for the ideal AWGN channel. Moreover, the sub-optimum joint decoder also performs close to the optimum joint decoding case, especially at higher SNR. In the case of different average SNRs (i.e., unbalanced SNR) between the links, the coding and modulation selection method will account for it. In other words, an SINR unbalance between the two UEs indicates that the UEs will transmit with different coding rates and/or different modulation schemes. Hence, the gain shown in the graph should not be affected.

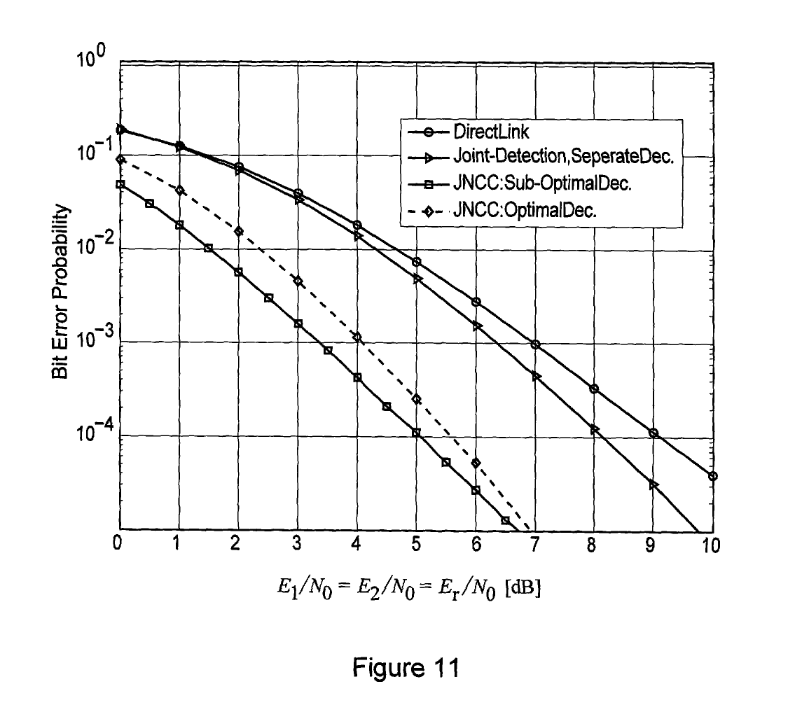

FIG. 11 is an example graph illustrating a relationship between average bit error rate versus signal to noise ratio for various decoding approaches using over Rayleigh fading channels. In the case of JNCC, both the optimal joint detection and sub-optimal processing approaches provide a better diversity gain, i.e., around 3 dB gain at BER of 10⁻³, as compared to joint detection and separate/individual decoding methods. The coding gain increases with the received SNR. Even the sub-optimum joint decoding algorithm yields 2.5 dB gain.

The technology described improves the signal quality received from source radio nodes and offers improved interaction between channel and network coding. The optimal detection is preferably based in an example embodiment on Viterbi Algorithm (VA) which uses maximum likelihood (ML) sequence estimation in contrast to ML symbol-by-symbol decoding required for turbo decoding. The joint processing approach described above is less complex as compared to JNCC based on turbo codes or LDPC codes since it does not requires soft information and is not an iterative decoding process. The technology may be used with any encoder constraint length. For example, the equivalent trellis formed at the destination node decoder may be the results of any two encoder rates, i.e., different generator matrices and/or different constraint lengths may be used. Concern about decoding complexity may be resolved using the reduced computation/complexity example embodiment which still achieves better performance than separate channel-network coding.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described, for it to be encompassed by the present claims. No claim is intended to invoke paragraph 6 of 35 USC §112 unless the words “means for” or “step for” are used. Furthermore, no embodiment, feature, component, or step in this specification is intended to be dedicated to the public regardless of whether the embodiment, feature, component, or step is recited in the claims.

1-29. (canceled)

30. A method implemented in a radio destination node, comprising:
directly receiving a first radio frequency (RF) signal from a first source radio node, the first RF signal including a coded first source information signal;
directly receiving a second RF signal from a second source radio node that is different from the first source radio node, the second RF signal including a coded second source information signal;
receiving a third RF signal from an intermediate network node that includes a network coded signal that is a combined coded information signal generated at the intermediate node after demodulating the coded first source information signal and the coded second source information signal received from the first and second source radio nodes; and
jointly processing the coded first source information signal, the coded second source information signal, and the combined coded information signal by operating on the coded first source information signal, the coded second source information signal, and the combined coded information signal together rather than individually to produce the first source information signal and the second source information signal.

31. The method of claim 30, wherein the jointly processing includes decoding the coded first source information signal, the coded second source information signal, and the combined coded information signal using the Viterbi algorithm.

32. The method of claim 30, wherein the jointly processing uses a single trellis to decode the coded first source information signal, the coded second source information signal, and the combined coded information signal.

33. The method of claim 32, wherein the single trellis selectively operates in one of a first operational mode using a first number of trellis states and a second operational mode using a second number of trellis states less than the first number.

34. The method of claim 33, where in the first operational mode, the jointly processing includes jointly decoding, using a single decoding algorithm, the coded first source information signal, the coded second source information signal, and the combined coded information signal together rather than individually to produce the first source information signal and the second source information signal.

35. The method of claim 33, where in the second operational mode, the jointly processing includes using fewer decoding computations than are required to perform the jointly processing in the first operational mode.

36. The method of claim 33, where in the second operational mode, the jointly processing includes decoding symbols from one of the first and second source radio nodes using a trellis decoding metric that is minimized over the symbols of the other source node to simplify decoding using the trellis.

37. The method of claim 30, wherein the coded first source information includes a first set of code words and the coded second source information includes a second set of code words.

38. The method of claim 37, wherein the intermediate node coding includes a network coding operation on the first and second set of code words, and wherein the network coding operation includes a combining of the first and second set of code words.

39. The method of claim 37, wherein the first and second sets of code words are associated with different time periods.

40. The method of claim 30, wherein the first coded source information and/or the second coded source information is convolutionally encoded.

41. The method of claim 30, wherein the first coded source information is coded with a first coder structure and the second coded source information is coded with a second different coder structure.

42. The method of claim 30, wherein the source radio nodes are mobile user equipment nodes and the destination node is a radio base station.

43. The method of claim 30, wherein the source radio nodes include radio base station nodes or one radio base station node and another intermediate node, and wherein the destination node is a mobile user equipment node.

44. Apparatus for a radio destination node, comprising:
a first signal processor configured to demodulate a first radio frequency (RF) signal received from a first source radio node, the first RF signal including a coded first source information signal;
a second signal processor configured to demodulate a second RF signal received from a second source radio node that is different from the first source radio node, the second RF signal including a coded second source information signal;
a third signal processor configured to demodulate a third RF signal from an intermediate network node that includes a combined coded information signal generated at the intermediate node after demodulating the coded first source information signal and the coded second source information signal received from the first and second source radio nodes; and
a joint processor configured to jointly process the coded first source information signal, the coded second source information signal, and the combined coded information signal by operating on the coded first source information signal, the coded second source information signal, and the combined coded information signal together to produce the first source information signal and the second source information signal.

45. The apparatus of claim 44, wherein the joint processor is configured to decode the coded first source information signal, the coded second source information signal, and the combined coded information signal using the Viterbi algorithm.

46. The apparatus of claim 44, wherein the joint decoder is configured to use a single trellis to decode the coded first source information signal, the coded second source information signal, and the combined coded information signal.

47. The apparatus of claim 46, wherein the joint decoder is configured to use the single trellis in one of a first operational mode using a first number of trellis states and a second operational mode using a second number of trellis states less than the first number.

48. The apparatus of claim 47, where in the second operational mode, the joint processor is configured to perform the joint processing with the simplified trellis using less decoding computations than would be required to perform the joint processing with an un-simplified trellis.

49. The apparatus of claim 47, where in the second operational mode, the joint processor is configured to decode symbols from one of the first and second source radio nodes using a decoding trellis metric that is minimized over the symbols of the other source node to simplify decoding using the trellis.

50. The apparatus of claim 44, wherein the coded first source information includes a first set of code words and the coded second source information includes a second set of code words, and wherein the first and second set of code words are associated with different time periods.

51. The apparatus of claim 44, wherein the first coded source information and/or the second coded source information is convolutionally encoded.

52. The apparatus of claim 44, wherein the first coded source information is coded with a first coder structure and the second coded source information is coded with a second different coder structure.

53. The apparatus of claim 44 implemented in the radio destination node.

54. The apparatus of claim 44, wherein the source radio nodes are mobile user equipment nodes and the destination node is a radio base station.

55. The apparatus of claim 44, wherein the source radio nodes are radio base station nodes and the destination node is a mobile user equipment node.

56. A radio base station (BS) comprising:
one or more antennas;
a first radio receiver, coupled to the one or more antennas, that demodulates a first radio frequency (RF) signal received from a first user equipment (UE) radio node, the first RF signal including a coded first UE information signal;
a second radio receiver, coupled to the one or more antennas, that demodulates a second RF signal received from a second UE radio node that is different from the first UE radio node, the second RF signal including a coded second UE information signal;
a third radio receiver, coupled to the one or more antennas, that demodulates a third RF signal received from an intermediate network node that includes a network coded signal which is a combined coded information signal generated at the intermediate node after demodulating the coded first UE information signal and the coded second UE information signal received from the first and second UE radio nodes;
a joint processor that jointly processes the coded first UE information signal, the coded second UE information signal, and the combined coded information signal by operating on the coded first UE information signal, the coded second UE information signal, and the combined coded information signal together rather than individually to produce the first UE information signal and the second UE information signal; and
a data processor for providing the produced first and second UE information signals to a communications interface.

57. The BS of claim 56, wherein the joint processor is a joint decoder configured to jointly decode, using a single decoding algorithm, the coded first source information signal, the coded second source information signal, and the combined coded information signal together rather than individually to produce the first source information signal and the second source information signal.

58. The BS of claim 56, wherein the joint processor is configured to use a trellis to decode symbols from one of the first and second source radio nodes using a trellis decoding metric that is minimized over the symbols of the other source node to simplify the trellis decoding.
